(19) United States
(12) Patent Application Publication
(10) Pub. No.: US 2007/0242464 A1
(43) Pub. Date: Oct. 18, 2007

(54) Essential oil diffusor

(75) Inventors: Ben-Mou Yu, Chung-Ho City (TW); Chung Yu Yin, Chung-Ho City (TW); Ching Wen Chang, Chung-Ho City (TW)

Correspondence Address: John Chen, Room 303, 3F., No.25, Sec.1, Changan E. Road, Taipei, 10441, TW

(73) Assignee: Wise Life Technology Co., Ltd.

(21) Appl. No.: 11/394,084

(22) Filed: Mar. 31, 2006

(51) Int. Cl. F21V 33/00; G09F 19/00

(52) U.S. Cl. 362/318; 40/407

(57) ABSTRACT

An essential oil diffusor assembly is disclosed. The diffusor assembly comprises a top cap having an opening, a diffusing member having a housing tip which is protruded out the opening of the top cap in order to prevent an essential oil from leaking out an inner surface of the top cap, an O-ring fastened on a bottom of the diffusing member, an air pump having a outlet for blowing out an air, a base, a flexible pipe attached to the outlet of the air pump and fixed on one top surface of the base, an oil reservoir having a holding bar formed on a bottom of the oil reservoir, wherein there exists a slender hole inside the holding bar so that the air pump is activated to let the air be supplied to the oil reservoir attached by the flexible pipe through the outlet of the air pump and the holding bar, a plurality of lighting elements disposed on the top surface of the base for emitting rays on the top cap and the oil reservoir in order to obtain good visual effects, a foam surrounding the air pump for absorbing a vibration and a noise, a mat disposed on a bottom of the air pump for absorbing a vibration and a noise, and a lower lid closing the bottom of the base, wherein the foam and the air pump are affixed on the lower lid and the diffusing member is sealed with the opening of the oil reservoir through the O-ring.

### BACKGROUND OF THE PRESENT INVENTION

1. Field of Invention

This invention relates to a diffusor, and more particularly to a diffusor utilizing Bernoulli's theorem and Lenard effect (Spray electrification, Waterfall effect) to finely vaporize essential oils in which the essential oil diffusor utilizes a top cap made of a transparent material or a semi-transparent material and plural pattern-printed inclined planes or fogged inclined planes to reflect or scatter the rays emitted by the lighting elements so as to vary the color of the rays in order to obtain good visual effects.

2. Description of Related Arts

FIG. 1 shows a conventional essential oil diffusor assembly. As shown in FIG. 1, the essential oil diffusor assembly 100 comprises an oil reservoir (i.e., essential oil bottle) 110, an oil jet 111, an air jet 112, an air pump 120, and a flexible pipe 130. The essential oil diffusor assembly 100 further comprises a casing mounted with the air pump 120 within it. The casing has a casing body which has three sockets 121 on the top surface of the casing body. As shown in FIG. 1, three blowholes 122 are provided in the lower part of the casing body in order to let the air be supplied to the air jet 112 from the air pump 120 by the flexible pipes 130 individually. The flexible pipe 130 made of silicone rubber or the like is used as connecting members for connecting the blowhole 122 and an inlet of the air jets 112. The oil reservoir (i.e., essential oil bottle) 110 has an opening 114 formed on the top thereof and a holding bar 113 formed on the bottom thereof. The holding bar 113 of the oil reservoir 110 is firmly engaged with the socket 121 when the holding bar 113 of the oil reservoir 110 is inserted within the socket 121. The oil jet 111 is disposed on the bottom of the oil reservoir 110 and has an inlet 115 on the bottom of the oil jet 111. The air jet 112 penetrates the oil reservoir 110 into the interior of the body of the oil reservoir 110.

Please refer to FIGS. 2A and 2B which are front section views illustrating an oil reservoir, an oil jet, and an air jet of FIG. 1 and a flow of the air passing through the oil reservoir and the air jet. As an essential oil 140 is poured into the oil reservoir 110 through the opening 114, the air pump 120 is activated to let the air be supplied to the oil reservoir 110 from the air pump 120 attached by the flexible pipe 130. As the air passes through the air jet 112 it reduces the pressure in the oil jet 111 and the oil reservoir 110 causing the essential oil 140 to be drawn up through the inlet 115 into the oil jet 111 because of Bernoulli's theorem. The oil is then diffused into the air. The air is continuously supplied to the top of the oil jet 111 through the air jet 112 so as to finely vaporize the essential oil. A lump of essential oils turns out to fine the minus ions according to the Lenard effect. Therefore, the majority of the minus ions are negatively charged because of the Lenard effect. The fine mist of the essential oils is then dispersed into the atmosphere through the opening 114 of the oil reservoir 110.

However, the output power efficiency of the air pump 120 have to be increased in order to increase the dispersed effect of the fine mist of the essential oils in the conventional essential oil diffusor assembly 100. In other words, the velocity of the air continuously supplied to the top of the oil jet 111 through the air jet 112 is increased so as to increase the dispersed effect of the fine mist of the essential oils such that the big operation noises occur.

### SUMMARY OF THE PRESENT INVENTION

It is therefore an object of the present invention to solve the foregoing problems in the conventional technology.

A main object of the present invention is to provide a diffusor assembly utilizing a flexible pipe attached to an outlet of an air pump and a holding bar formed on a bottom of an oil reservoir wherein there exists a slender hole inside the holding bar so that the air pump is activated to let the air be supplied to the oil reservoir attached by the flexible pipe through the outlet of the air pump and the holding bar.

Another object of the present invention is to provide a diffusor assembly utilizing a flexible pipe fastened to an outlet of an air pump and a holding bar formed on a bottom of an oil reservoir in order to eliminate the vibration and noise caused by the air pump.

Another object of the present invention is to provide a diffusor assembly utilizing an O-ring fastened on a bottom of the diffusing member in order to eliminate the noise caused by the blowing of the air jet through the O-ring.

Another object of the present invention is to provide a diffusor assembly utilizing a combination of a top cap and a base to dispose the diffusing member, the O-ring, and the oil reservoir inside the space formed by the top cap and the base, wherein the top cap is made of a transparent material or a semi-transparent material and has four inclined planes such that each of the four inclined planes could reflect the rays emitted by the lighting elements and the light of the lighting elements can irradiate the inner surface of the oil reservoir. In addition, there are patterns printed on each of inclined planes or the inclined planes are fogged such that the rays emitted by the lighting elements are reflected or scattered by the inclined planes so as to vary the color of the rays in order to obtain good visual effects.

Accordingly, in order to accomplish the one or some or all above objects, the present invention provides a diffusor assembly comprising:

a top cap having an opening;

a diffusing member having a housing tip which is protruded out the opening of the top cap in order to prevent an essential oil from leaking out an inner surface of the top cap;

an O-ring fastened on a bottom of the diffusing member;

an air pump having a outlet for blowing out an air;

a base;

a flexible pipe attached to the outlet of the air pump and fixed on one top surface of the base;

an oil reservoir having a holding bar formed on a bottom of the oil reservoir, wherein there exists a slender hole inside the holding bar so that the air pump is activated to let the air be supplied to the oil reservoir attached by the flexible pipe through the outlet of the air pump and the holding bar;

a plurality of lighting elements disposed on the top surface of the base for emitting rays on the top cap and the oil reservoir in order to obtain good visual effects;

a foam surrounding the air pump for absorbing a vibration and a noise;

a mat disposed on a bottom of the air pump for absorbing a vibration and a noise; and

a lower lid closing the bottom of the base, wherein the foam and the air pump are affixed on the lower lid and the diffusing member is sealed with the opening of the oil reservoir through the O-ring.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 is a conventional essential oil diffusor assembly.

FIGS. 2A and 2B are front section views illustrating an oil reservoir, an oil jet, and an air jet and a flow of the air passing through the oil reservoir and the air jet of FIG. 1.

FIGS. 3˜6 are a perspective view of a diffusor assembly according to a preferred embodiment of the present invention.

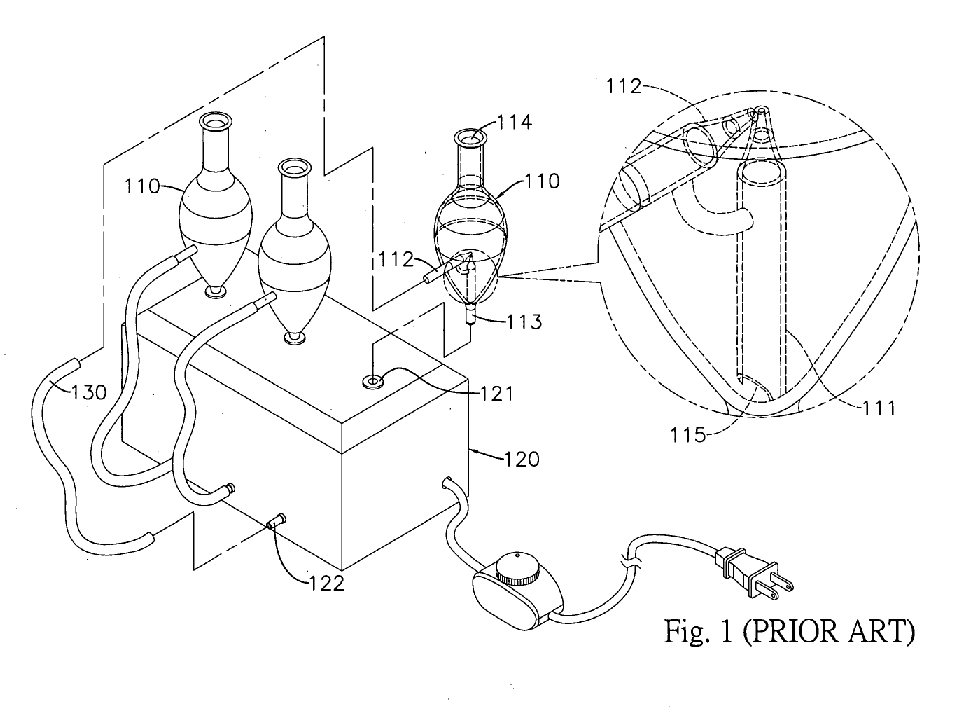

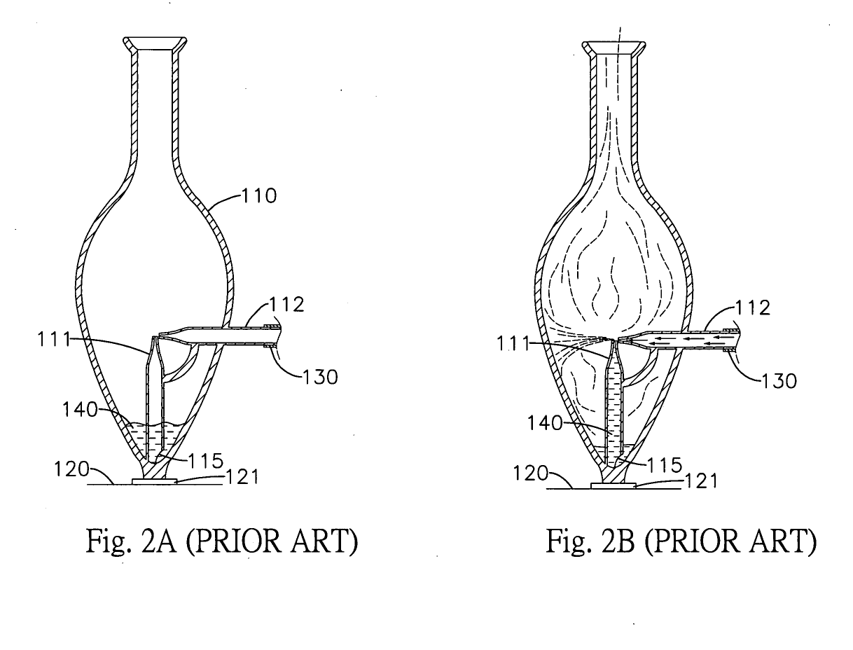

### DETAILED DESCRIPTION OF THE PREFERRED EMBODIMENT

In describing preferred embodiments of the present invention illustrated in the drawings, specific terminology is employed for the sake of clarity. However, the invention is not intended to be limited to the specific terminology so selected, and it is to be understood that each specific element includes all technical equivalents which operate in a similar manner to accomplish a similar purpose. Furthermore, directional indicators such as “top”, “bottom”, “left”, “right” and so forth, are provided for the convenience of the reader in referencing particular elements or relationships of elements in exemplary embodiments of the invention, but do not in any way limit the invention to such orientations or configurations.

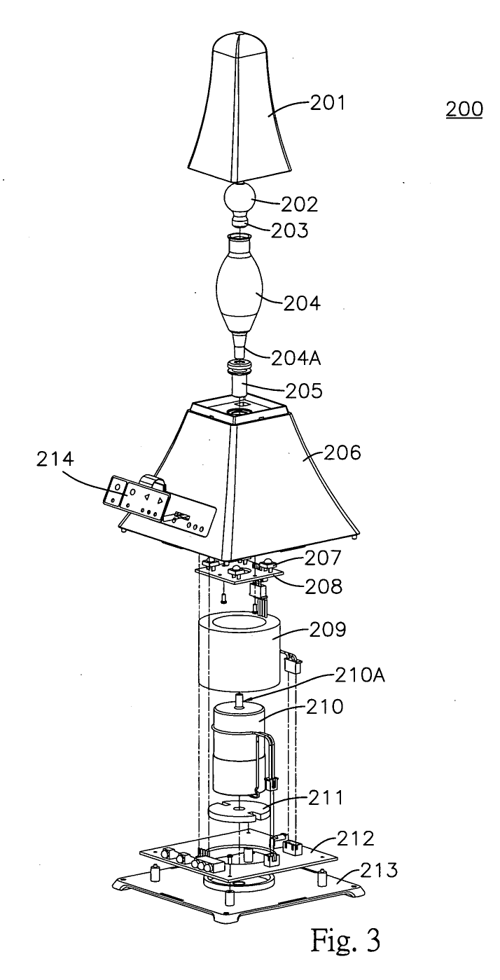

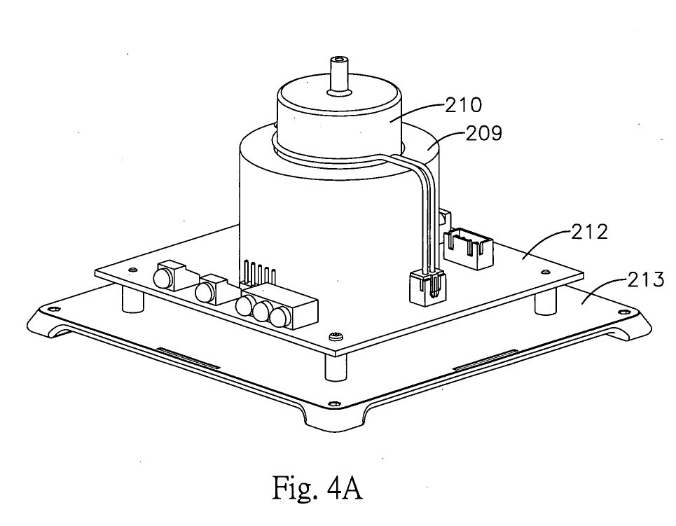

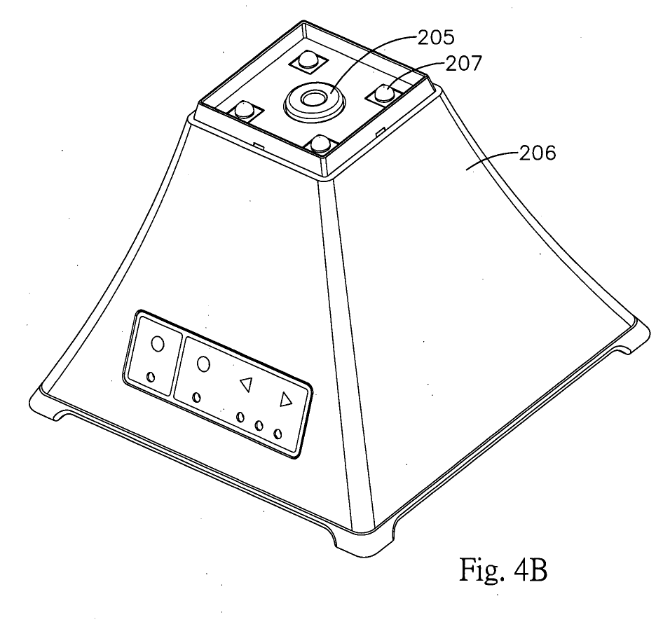

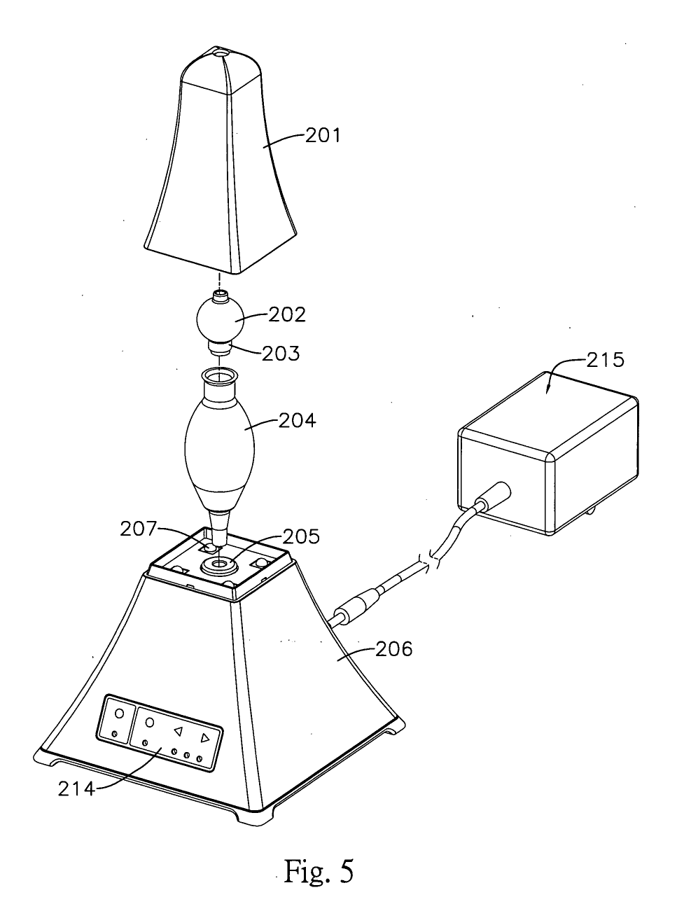

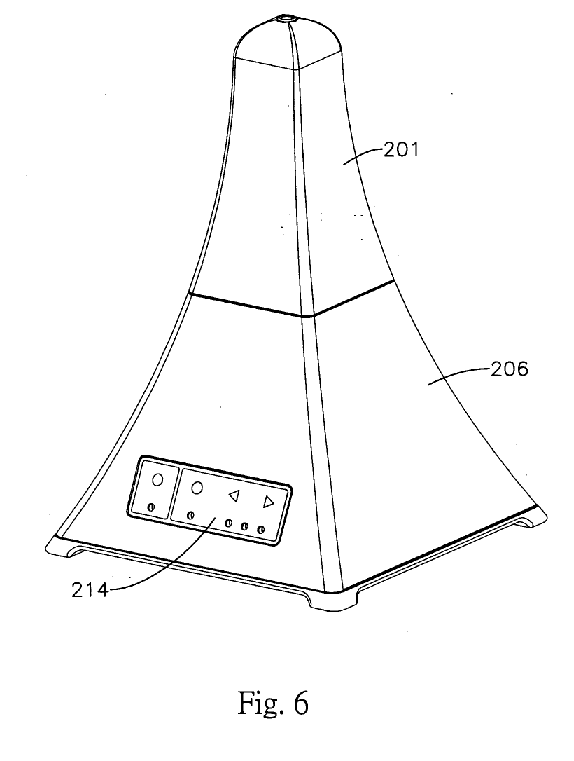

Referring to FIGS. 3˜6, a perspective view of a diffusor assembly according to a preferred embodiment of the present invention is illustrated. As shown in FIG. 3, the diffusor assembly 200 mainly comprises a top cap 201, a diffusing member 202, an O-ring 203, an oil reservoir 204, a flexible pipe 205, a base 206, a plurality of lighting elements 207, a first circuit board 208, a foam 209, an air pump 210, a mat 211, a second circuit board 212, and a lower lid 213. The lower lid 213 closes the bottom of the base 206.

In this preferred embodiment, there exists a holding bar 204A formed on the bottom of the oil reservoir 204. The air pump 210 is activated to let the air be supplied to the oil reservoir 204 from the air pump 210 attached by the flexible pipe 205. The holding bar 204A formed on the bottom of the oil reservoir 204 is fitted into an opening of the flexible pipe 205. An outlet 210A of the air pump 210 is fitted into the other opening of the flexible pipe 205. There exists a slender hole inside the holding bar 204A so that the air pump 210 is activated to let the air be supplied to the oil reservoir 204 attached by the flexible pipe 205 through the outlet 210A and the holding bar 204A. In addition, the flexible pipe 205 is fixed on one top surface of the base 206 and is press-fitted with the outlet 210A and the holding bar 204A such that this arrangement could reduce the noise and the vibration caused by the air pump 210.

As an essential oil is poured into the oil reservoir 204 through the opening, the air pump 210 is activated to let the air be supplied to the oil reservoir 204 from the air pump 210 attached by the flexible pipe 205. The oil reservoir 204 comprises an air jet (not shown in figures) and an oil jet (not shown in figures) inside. The bottom inlet of the air jet is directly connected to the holding bar 204A formed on the bottom of the oil reservoir 204. As the air passes through the air jet (not shown in figures) it reduces the pressure in the oil jet (not shown in figures) and the oil reservoir 204 causing the essential oil to be drawn up through an inlet of the oil jet into the oil jet because of Bernoulli's theorem. The oil is then diffused into the air. The air is continuously supplied to the top of the oil jet through the air jet so as to finely vaporize the essential oil. A lump of essential oils turns out to fine the minus ions according to the Lenard effect. Therefore, the majority of the minus ions are negatively charged because of the Lenard effect. The fine mist of the essential oils is then dispersed into the atmosphere through the opening of the oil reservoir 204.

Further, the O-ring 203 could be made of silicon rubber or the like. The O-ring 203 is fastened on the bottom of the diffusing member 202. Through the O-ring 203, the diffusing member 202 could be press-fitted with the opening of the oil reservoir 204 so that the noise caused by the blowing of the air jet could be eliminated. In other words, the noise caused by the blowing of the air jet could be eliminated because the diffusing member 202 could be sealed with the opening of the oil reservoir 204 through the O-ring 203.

The plural lighting elements 207 disposed on the top surface of the base 206 are electrically connected to the first circuit board 208. The plural lighting elements 207 could be Light Emitting Diodes (LEDs). Through the adjustment of the brightness of the full-color LEDs and the gradual color change of the full-color LEDs, the rays emitted by the full-color LEDs are illuminated and projected on the surface of the oil reservoir 204 so as to increase the whole aesthetic sensibilities of the diffusor assembly.

Moreover, the top cap 201 is rested on the top of the base 206 and closes the top of the base 206 to form the diffusor assembly. The diffusing member 202, the O-ring 203, and the oil reservoir 204 are placed inside the space formed by the top cap 201 and the base 206. The top cap 201 is made of a transparent material or a semi-transparent material and has four inclined planes. Each of the four inclined planes could reflect the rays emitted by the lighting elements 207 so that the light of the lighting elements 207 can irradiate the inner surface of the oil reservoir 204. In addition, there are patterns printed on each of inclined planes or the inclined planes are fogged such that the rays emitted by the lighting elements 207 are reflected or scattered by the inclined planes so as to vary the color of the rays in order to obtain good visual effects.

Still further, the diffusing member 202 has a housing tip which is protruded out the opening of the top cap 201 in order to prevent the essential oil from leaking out the inner surface of the top cap 201.

Referring to FIGS. 3 and 4A, a perspective view of a diffusor assembly according to a preferred embodiment of the present invention is illustrated. As shown in FIGS. 3 and 4A, the foam 209 surrounds the air pump 210 and the mat 211 is disposed on the bottom of the air pump 210. The foam 209 and the air pump 210 are affixed in a hollow portion of the second circuit board 212. In addition, the foam 209, the air pump 210, and the second circuit board 212 are affixed on the lower lid 213. The foam 209 and the mat 211 could be utilized to absorb the vibration and the noise caused by the air pump 210. Besides, the second circuit board 212 comprises at least one control IC to control the lighting elements 207 and the air pump 210 respectively. Through the control IC, the air pump 210 could have three types of output powers such as HIGH, MIDDLE, and LOW. The PWM control technique is utilized to control the air pump 210 under burst mode control. For example, let the air pump 210 be operative under normal operation for two minutes and then next two minutes let the air pump 210 be operative during the “off” portion of burst mode dimming cycles. The air pump 210 continuously is turned on and off and regularly repeated in the same order for two hours. Then the air pump 210 is stopped. Additionally, the lighting elements 207 could be controlled by the control IC independently, which could not be affected by this manner that the diffusor assembly stops to supply power to the air pump 210. Hence the diffusor assembly could also be used as a light lamp.

Referring to FIGS. 3, 4B and 5˜6, a perspective view of a diffusor assembly according to a preferred embodiment of the present invention is illustrated. As shown in FIGS. 3, 4B and 5˜6, the diffusor assembly 200 further comprises a control panel 214 which has a power-on button, three types of output power control buttons such as HIGH, MIDDLE, and LOW, and a power-on button of the lighting elements 207.

Referring to FIG. 5, the diffusor assembly 200 further comprises a transformer 215 which is utilized to supply power to the diffusor assembly 200. In addition, the diffusor assembly 200 further comprises a battery set (not shown in figures) to be powered by the transformer 215. When the transformer 215 stops to supply power to the diffusor assembly 200, the battery set could supply power to the diffusor assembly 200.

One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A diffusor assembly comprising:
a top cap having an opening;
a diffusing member having a housing tip which is protruded out said opening of said top cap in order to prevent an essential oil from leaking out an inner surface of said top cap;
an O-ring fastened on a bottom of said diffusing member;
an air pump having a outlet for blowing out an air;
a base;
a flexible pipe attached to said outlet of said air pump and fixed on one top surface of said base;
an oil reservoir having a holding bar formed on a bottom of said oil reservoir, wherein there exists a slender hole inside said holding bar so that said air pump is activated to let said air be supplied to said oil reservoir attached by said flexible pipe through said outlet of said air pump and said holding bar;
a plurality of lighting elements disposed on said top surface of said base for emitting rays on said top cap and said oil reservoir in order to obtain good visual effects;
a foam surrounding said air pump for absorbing a vibration and a noise;
a mat disposed on a bottom of said air pump for absorbing a vibration and a noise; and
a lower lid closing said bottom of said base, wherein said foam and said air pump are affixed on said lower lid and said diffusing member is sealed with said opening of said oil reservoir through said O-ring.

2. The diffusor assembly, as recited in claim 1, further comprising a first circuit board electrically connected to said plural lighting elements for adjusting a brightness of said plural lighting elements and a gradual color change of said plural lighting elements.

3. The diffusor assembly, as recited in claim 1, further comprising a second circuit board electrically connected to said air pump for controlling the output power of said air pump.

4. The diffusor assembly, as recited in claim 3, wherein said second circuit board has a hollow portion in order to let said foam and said air pump be affixed in said hollow portion.

5. The diffusor assembly, as recited in claim 1, wherein said top cap is made of one of a transparent material and a semi-transparent material and has plural inclined planes to reflect rays emitted by said lighting elements.

6. The diffusor assembly, as recited in claim 5, wherein said inclined planes are one of pattern-printed inclined planes and fogged inclined planes to reflect rays emitted by said lighting elements.

7. The diffusor assembly, as recited in claim 1, further comprising a control panel which has a power-on button and three types of output power control buttons.

8. The diffusor assembly, as recited in claim 7, wherein said control panel further comprises a power-on button of said lighting elements.

9. The diffusor assembly, as recited in claim 1, wherein said flexible pipe is fixed on said top surface of said base and is press-fitted with said outlet of said air pump in order to reduce said noise and said vibration caused by said air pump.

10. The diffusor assembly, as recited in claim 1, wherein said O-ring is made of silicon rubber and is fastened on said bottom of said diffusing member 202 in which through said O-ring, said diffusing member is press-fitted with said opening of said oil reservoir in order to eliminate said noise.

11. The diffusor assembly, as recited in claim 1, wherein said lighting elements are Light Emitting Diodes.

12. The diffusor assembly, as recited in claim 1, further comprising a battery set to supply power to said diffusor assembly.

13. A diffusor assembly comprising:
an air pump having a outlet for blowing out an air;
a base;
a flexible pipe attached to said outlet of said air pump and fixed on one top surface of said base; and
an oil reservoir having a holding bar formed on a bottom of said oil reservoir, wherein there exists a slender hole inside said holding bar so that said air pump is activated to let said air be supplied to said oil reservoir attached by said flexible pipe through said outlet of said air pump and said holding bar.

14. The diffusor assembly, as recited in claim 13, further comprising:
a top cap having an opening;
a diffusing member having a housing tip which is protruded out said opening of said top cap in order to prevent an essential oil from leaking out an inner surface of said top cap; and
an O-ring fastened on a bottom of said diffusing member so as to let said diffusing member is sealed with an opening of said oil reservoir.

15. The diffusor assembly, as recited in claim 14, further comprising a plurality of lighting elements disposed on said top surface of said base for emitting rays on said top cap and said oil reservoir in order to obtain good visual effects.

16. The diffusor assembly, as recited in claim 13, further comprising a foam surrounding said air pump for absorbing a vibration and a noise.

17. The diffusor assembly, as recited in claim 13, further comprising a mat disposed on a bottom of said air pump for absorbing a vibration and a noise.

18. The diffusor assembly, as recited in claim 16, further comprising a lower lid closing said bottom of said base, wherein said foam and said air pump are affixed on said lower lid and said diffusing member is sealed with said opening of said oil reservoir through said O-ring.

19. The diffusor assembly, as recited in claim 18, further comprising a first circuit board electrically connected to said plural lighting elements for adjusting a brightness of said plural lighting elements and a gradual color change of said plural lighting elements.

20. The diffusor assembly, as recited in claim 18, further comprising a second circuit board electrically connected to said air pump for controlling the output power of said air pump.
